(19) United States
(12) Patent Application Publication
(10) Pub. No.: US 2016/0001196 A1
(43) Pub. Date: Jan. 7, 2016

(54) SYSTEM FOR THE SEPARATION OF GASES FROM SOLIDS AND FLUIDS

(71) Applicant: Richard Lyle Shown, Santa Rosa, CA (US)

(72) Inventor: Richard Lyle Shown, Santa Rosa, CA (US)

(21) Appl. No.: 14/754,335

(22) Filed: Jun. 29, 2015

Related U.S. Application Data
(60) Provisional application No. 62/020,891, filed on Jul. 3, 2014.

(51) Int. Cl. B01D 3/00; F25B 39/00

(52) U.S. Cl. CPC B01D 3/00; F25B 39/00; F25B 39/02

(57) ABSTRACT

A system for separating gases from solids and fluids, including a containment chamber having an upper chamber portion, a lower chamber portion disposed immediately below said upper chamber portion, and a heat exchange partition disposed between and separating said upper chamber portion from said lower chamber portion; means for conveying the feedstock into the upper chamber and for conveying the gas-containing solids and/or liquids from the upper chamber; a heat source in fluid communication with said lower chamber portion for circulating heated fluid through said lower chamber portion to and from said heat source; and a gas removal and storage apparatus to remove gases separated from the feedstock in said upper chamber portion and to then store such gases in a gas storage tank.

### CROSS REFERENCES TO RELATED APPLICATIONS

The present application claims the benefit of U.S. Provisional Patent Application Ser. No. 62/020,891 filed Jul. 3, 2014 (Jul. 3, 2014), which application is incorporated in its entirety by reference herein.

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION BY REFERENCE OF MATERIAL SUBMITTED ON A COMPACT DISC

Not applicable.

### BACKGROUND OF THE INVENTION

1. Field of the Invention

The present invention relates most generally to chemical separation process, and more particularly to methods of separating gases from solids and liquids, and still more particularly to a system and method for separating gases from solid and liquid feedstock involving the use of a heat chamber using heated water or other heat exchange fluids to heat the solid and/or liquid feedstock so as to accelerate the evaporation of gases from the feedstock.

2. Background Discussion

Under some conditions gases, such as methane and certain alcohols, will permeate certain solids and liquids by dissolving into the substrate even past the point of saturation. A case in point is the absorption of methane by groundwater, thereby rendering it unfit for human consumption. Another case in point is the decomposition of organic matter in soil or landfills or compost piles into various volatile compounds. Where massive amounts of either human or animal waste are processed, it is necessary to apply heat to separate the methane and other volatile gases from the biomass. Once the gases have been separated from the biomass, they can be sterilized with high heat in a short period of time. The resulting compound of chemicals and nutrients contained in the sterilized biomass can be used for soil amendments or other appropriate beneficial uses.

Heavily populated areas are challenged to disposing of municipal solid waste (MSW) in large volumes. Most MSW are transported to landfills where they are buried with other debris, both natural and artificial. Landfills, however, have several adverse environmental impacts, in consequence of which less destructive and less expensive means for disposing of MSW have been sought.

It is known that MSW contains embodied energy that can be released through gas extraction (gasification) and combustion technologies. Combustion, unfortunately, involves the release of toxic gases from the combustion chamber, including dioxins and furans, requiring the use of gas capturing and sequestering technologies to reduce and limit such releases. Such technologies include electrostatic precipitators, adsorption on activated carbon, filtration, flocculation and sedimentation, and the like.

Gasification is a process for removing gases dissolved or otherwise entrapped in solid and liquid wastes through a process of devolatilizing the hydrocarbon gases and converting them into a low or medium BTU gas. Gasification facilities release and store useful gases for fuel uses of many kinds, both for the conversion of chemical to mechanical energy and for the production of electricity.

There are now numerous commercial, industrial, institutional, and government processes that require dissolved gases to be separated from the various solids and liquids in which they are diffused. As indicated above, gasification may be employed to separate hydrocarbons from MSW. In fact, simply by heating the impacted solid or liquid to a sufficiently high temperature, volatile gases diffused in the solids and/or liquids may be separated by evaporation, and thereafter they may be condensed and pressurized for large scale industrial, commercial, and municipal uses. The elevation in temperature simply initiates and/or accelerates the evaporation process. Currently, however, these processes require the use of energy from fossil fuels.

Accordingly, it would be desirable to have a gasification process driven by a renewable energy source that provides heat for the gas evaporation and separation. To that end, the present inventor has conceived two principal ways to provide such energy. A first such system, described in U.S. Utility patent application Ser. No. 13/794,538, Pub. No. 2014/0251414, entitled, “Hybrid solar thermal and photovoltaic system with thermal energy capture subsystem” (incorporated in its entirety by reference herein), comprises photovoltaic solar panels, each attached to base with an open top, a bottom, and sides. A base cover is connected to the base sides to define a fluid reservoir. A fluid inlet disposed in each side of the bases provides water to the reservoir from a water supply. A fluid outlet disposed in the sides of each base discharges heated water from the reservoirs through a discharge pipe connected to hot water storage tanks. Electrically controlled valves on the inlet and outlets are under the control of a controller coupled to temperature sensors in the reservoirs, such that water is released from the reservoirs and replenished to the reservoirs only after water contained in the reservoirs reaches a predetermined temperature. Water heated in the system may be captured and stored in highly insulated storage tanks or sent to the complementary subsystem for separating suffused gases encapsulated or trapped in solids or liquids, as described herein.

A second such system is described in U.S. Utility patent application Ser. No. 14/335,840, entitled, System and method for extracting subterranean heat” (also incorporated in its entirety by reference herein), describes a system for extracting heat from underground heat sources. The system includes heat exchangers disposed in bore holes of relatively shallow depths of between 200 meters and 600 meters. A water supply coupled to a water supply and steam return pipe assemblies for each heat exchanger delivers water to, and returns steam from, the heat exchangers. A steam collection manifold consolidates steam generated in the heat exchangers and returned through the water supply and steam return pipe assemblies. Again, the steam and/or heated water may be used in the gas separation system described herein.

### SUMMARY OF THE INVENTION

The present invention is a system for separating gases from solids and fluids that includes, most summarily, a containment chamber having an upper chamber portion, a lower chamber portion disposed immediately below the upper chamber portion, and a heat exchange partition disposed between and separating the upper and lower chamber portions. Gas-containing solid or liquid feedstock is conveyed into and from the upper chamber portion during operation. A heat source in fluid communication with the lower chamber portion circulates heated fluid through the lower chamber portion and heats the heat exchange partition, which, in turn, heats the feedstock to a temperature sufficient to evaporate and volatilize the entrapped gases. A gas removal and storage apparatus removes the separated gases and directs them to a pressurized storage tank where they are stored for later use.

### BRIEF DESCRIPTION OF SEVERAL VIEWS OF THE DRAWINGS

The present invention will be better understood and objects other than those set forth above will become apparent when consideration is given to the following detailed description thereof. Such description makes reference to the annexed drawing wherein:

FIG. 1 is a highly schematic view showing the structural and operational elements of the inventive system for separating gases from solids and liquids.

### DETAILED DESCRIPTION OF THE INVENTION

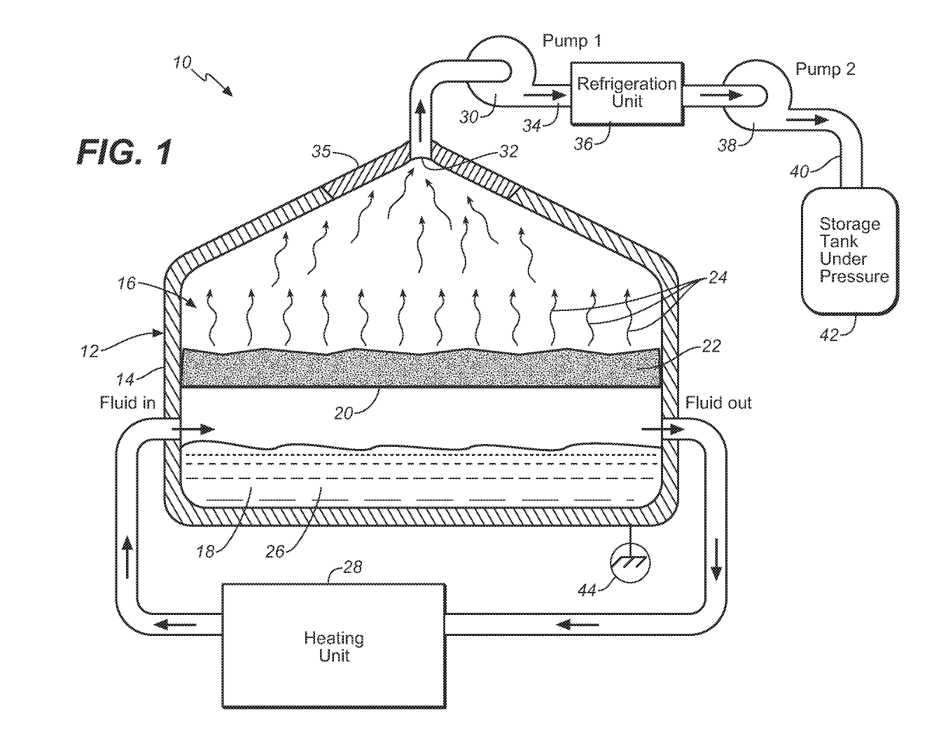

Referring to FIG. 1, there is shown, in highly schematic form, an inventive evaporation and separation system 10. The separation system includes a gas separation unit 12, comprising a containment chamber 14 bifurcated into upper and lower chamber portions 16, 18 by a heat exchange partition 20. The upper chamber portion is a watertight and gastight chamber into and through which gas-containing solids and/or liquids 22 (the “feedstock”) are conveyed for the separation of gases 24. The lower chamber portion 18 is disposed immediately below the heat exchange partition 20 and is a space into and through which heated fluids 26 are passed. Means for introducing the feedstock (gas-containing solids and/or liquids) 22 into the upper chamber portion 16 and removing the gas-containing solids and/or liquids from the upper chamber portion are not shown but are numerous and well-known to include manual means, such as a simple access door or cover for introducing or removing the material manually, an automated conveyor system for introducing the material into the upper chamber portion for a predetermined amount of time or until the material is sufficiently processed and the gasses removed, a hopper and gravity feed system, positive displacement pumps, and so forth. Accordingly, the means for such an operation are non-limiting and do not form an essential element of the inventive system.

The separation unit works independently and equally well regardless of the particular source 28 of thermal energy, assuming sufficient temperatures can be achieved in the upper chamber portion of the separation chamber. That is, the heated fluid can be provided by any source capable of heating water or other fluid substance to a sufficient degree that it can be transferred through the heat exchange partition to the feedstock in the upper chamber portion, thereby heating the feedstock sufficiently to induce the separation of gases contained within the feedstock. The heat source may be a thermal waste byproduct of another useful process, such as operating an engine or motor or combusting other materials for energy production or other purposes. As will be readily appreciated, the heated fluid passing through the lower chamber portion simply heats the heat exchange partition such that it acts as a kind of heating plate for the feedstock. To the extent that the separation chamber in its entirety is heated by the heated fluid, the walls of the upper chamber portion will also contribute to heating.

The top of the upper chamber is configured as an inverted funnel under negative pressure from a vacuum pump 30. The evaporated/separated gases are concentrated and collected through an opening 32 to a gas outlet tube 34. The top 35 is either affixed by welding the inverted funnel to the heat producing unit, or in certain cases, such as sewage and or animal refuse, the gaseous integrity of the top unit may be a sealed plastic membrane in order to prevent gas from escaping into the atmosphere. The top 35 may also be a hinged clamped lid with gaskets for sealingly securing it to the upper chamber portion 16 of the containment chamber 14.

After the evaporated gases are channeled through the gas outlet tube 34, they are next pumped through a refrigeration unit 36 and thereafter pumped 38 through pipes 40 into a pressure tank 42, where they may be put under pressure for storage and later industrial or commercial purposes. Refrigeration is applied only as necessary for this purpose, and the refrigerant is not mixed with the gases but only circulated around a refrigeration chamber. Gas backflow devices are employed throughout to prevent the reversal of the cooler gas back to the evaporative chamber.

The above-described evaporation/separation process can be adapted to complex conditions involving soluble solids and debris slurries from which entrapped gases are constantly evaporating and being fermented (or off-gassing) from a heated solution. For instance, in the case of municipal solid waste (MSW), efficient large-scale structures must be engineered to handle the large volume through-put. The source of the heat energy and the evaporation/separation structure, however, can be the same.

The structures must be electrically grounded 44 to prevent ignition of the volatile gases by static electricity buildup. In addition, the entire system can be made mobile through installation on a low-boy trailer for transport to an affected site. The military may use the inventive system for treating drinking water in advanced locations and bases and may use the system as a self-contained sewage treatment facility.

In its most essential aspect, therefore, the inventive gas separation and removal system includes a containment chamber having an upper chamber portion, a lower chamber portion disposed immediately below said upper chamber portion, and a heat exchange partition disposed between and separating said upper chamber portion from said lower chamber portion; means for conveying the feedstock into the upper chamber and for conveying the gas-containing solids and/or liquids from the upper chamber; a heat source in fluid communication with said lower chamber portion for circulating heated fluid through said lower chamber portion to and from said heating source; and a gas removal and storage apparatus to remove gases separated from the feedstock in said upper chamber portion and to then store such gases in a gas storage tank.

A method of separating gases from feedstock is implicit in the inventive system, and includes the steps of (a) providing a separation/evaporation apparatus including a containment chamber with an upper chamber portion, a lower chamber portion disposed immediately below the upper chamber portion, and a heat exchange partition disposed between and separating the upper and lower chamber portions; apparatus for conveying feedstock into the upper chamber and for conveying the gas-containing solids and/or liquids from the upper chamber; a heat source in fluid communication with the lower chamber portion for circulating heated fluid through the lower chamber portion to and from the heat source; and a gas removal and storage apparatus to remove gases separated from the feedstock in said upper chamber portion and to then store such gases in a gas storage tank; (b) introducing gas-containing feedstock into the upper chamber portion; (c) circulating heating fluid from the heat source through the lower chamber portion so as to bring the feedstock up to a temperature sufficient to volitalize and evaporate gases dissolved or otherwise entrapped in the feedstock; and (d) containing and storing the evaporated gases in a gas storage tank.

The foregoing disclosure will enable one of ordinary skill in the art to practice the invention without any significant experimentation. It further provides the best mode of practicing the invention presently contemplated by the inventor. Even so, while there is provided herein a full and complete disclosure of the preferred embodiments of this invention, it does not limit the invention to the exact construction and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. A system for separating gases from solids and fluids, comprising:
a containment chamber having an upper chamber portion, a lower chamber portion disposed immediately below said upper chamber portion, and a heat exchange partition disposed between and separating said upper chamber portion from said lower chamber portion;
means for conveying the feedstock into said upper chamber portion and for conveying the gas-containing solids and/or liquids from said upper chamber portion;
a heat source in fluid communication with said lower chamber portion for circulating heated fluid through said lower chamber portion to and from said heat source; and
a gas removal and storage apparatus to remove gases separated from the feedstock in said upper chamber portion and to then store such gases in a gas storage tank.

2. The system of claim 1, wherein said upper chamber portion is a watertight and gas-tight chamber into and through which the feedstock may be conveyed for the separation of volatile gases.

3. The system of claim 2, wherein said lower chamber portion is a space into and through which heated fluids are passed.

4. The system of claim 1, wherein said heat source provides a heated fluid to said lower chamber portion.

5. The system of claim 4, wherein said heat source is a thermal waste byproduct of a useful energy conversion process.

6. The system of claim 5, wherein said energy conversion process is engine operation, motor operation, or combustion of materials for energy production or other purposes.

7. The system of claim 1, wherein said upper chamber portion is under negative pressure from a vacuum pump to induce removal of volatile gases separated from the feedstock.

8. The system of claim 7, wherein said upper chamber portion is configured as an inverted funnel having a top.

9. The system of claim 8, wherein said top of said upper chamber portion is welded to said upper chamber portion.

10. The system of claim 8, wherein said upper chamber portion includes a top comprises a hinged clamped lid with gaskets for sealingly securing it to said upper chamber portion of said containment chamber.

11. The system of claim 8, wherein said upper chamber portion includes an opening in fluid communication with a gas outlet tube, such that evaporated and separated gases are concentrated and collected through said opening and directed to said outlet tube.

12. The system of claim 11, further including a refrigeration unit in fluid communication with said gas outlet tube and a pump operatively connected to said refrigeration unit, wherein evaporated gases are channeled through said gas outlet tube and pumped through said refrigeration unit to cool said gases.

13. The system of claim 12, further including a pressurized gas storage tank in fluid communication with said refrigeration unit, wherein gases pumped through said refrigeration unit are pumped into said pressurized gas storage tank.

14. The system of claim 13, further including gas backflow devices for preventing the cooled gases from traveling back to said containment chamber.

15. A method of separating gases from liquid or solid feedstock, comprising the steps of:
(a) providing a separation/evaporation apparatus including a containment chamber with an upper chamber portion, a lower chamber portion disposed immediately below the upper chamber portion, and a heat exchange partition disposed between and separating the upper and lower chamber portions; apparatus for conveying feedstock into the upper chamber and for conveying the gas-containing solids and/or liquids from the upper chamber; a heat source in fluid communication with the lower chamber portion for circulating heated fluid through the lower chamber portion to and from the heat source; and a gas removal and storage apparatus to remove gases separated from the feedstock in said upper chamber portion and to then store such gases in a gas storage tank;
(b) introducing gas-containing feedstock into the upper chamber portion;
(c) circulating heating fluid from the heat source through the lower chamber portion so as to bring the feedstock up to a temperature sufficient to volitalize and evaporate gases dissolved or otherwise entrapped in the feedstock; and
(d) containing and storing the evaporated gases in a gas storage tank.
